(19) United States
(12) Patent Application Publication
(10) Pub. No.: US 2006/0015468 A1
(43) Pub. Date: Jan. 19, 2006

(54) Dynamic allocation of postal security devices

(76) Inventor: James M. Mattern, Bethany, CT (US)

Correspondence Address: PERMAN & GREEN, 425 POST ROAD, FAIRFIELD, CT, 06824, US

(21) Appl. No.: 10/766,975

(22) Filed: Jan. 29, 2004

Related U.S. Application Data
(60) Provisional application No. 60/516,798, filed on Nov. 3, 2003.

(51) Int. Cl. G06F 17/00; G06F 9/00

(52) U.S. Cl. 705/410; 705/401

(57) ABSTRACT

A system for dynamically allocating one or more postal security devices (PSD's), includes an indicia pool utilizing PSD's for generating indicia, a download pool for refreshing PSD funds, and a means for allocating the one or more PSD's among the indicia pool and download pool according to indicia generating requirements and funding amounts within the one or more PSD's.

### BACKGROUND

1. Field of the Invention

The disclosed embodiments relate to franking operations and, more particularly, to a franking system that utilizes a number or more postal security devices (PSD's).

2. Brief Description of Related Developments It would be advantageous to provide a system that allocates one or more PSD's to different functions according to indicia generating requirements and funding amounts within the one or more PSD's.

### SUMMARY OF THE INVENTION

The present invention is directed to a system that generally provides a mechanism where multiple PSD's may produce indicia at a high rate, and a robust software architecture that provides for refreshing of PSD funds when required and for diagnostic and corrective action in the event of PSD hardware and software failure. The disclosed embodiments are directed to a system for dynamically allocating one or more postal security devices (PSD's), including an indicia pool utilizing PSD's for generating indicia, a download pool for refreshing PSD funds, and a means for allocating the one or more PSD's among the indicia pool and download pool according to indicia generating requirements and funding amounts within the one or more PSD'S.

### BRIEF DESCRIPTION OF THE DRAWINGS

The foregoing aspects and other features of the disclosed embodiments are explained in the following description, taken in connection with the accompanying drawings, wherein:

FIG. 1 shows a system according to the disclosed embodiments;

FIG. 2 shows an example where a web server operates as an interface between the system and a client browser.

FIG. 3 shows an example of the disclosed embodiments implemented in a retailing system.

FIG. 4 shows an example of the disclosed embodiments implemented in an open system.

FIG. 5 shows an example of the disclosed embodiments implemented in a closed system.

### DETAILED DESCRIPTION OF THE EMBODIMENT(S)

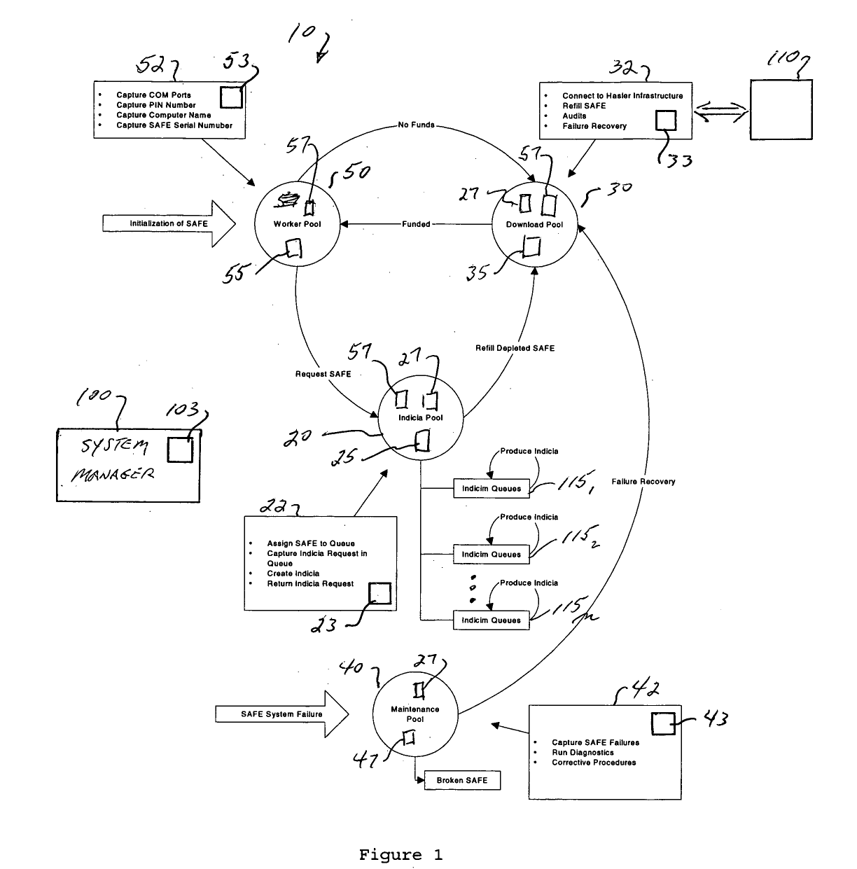

Referring to FIG. 1, a system 10 incorporating features of the disclosed embodiments is illustrated. Although the embodiments disclosed will be described with reference to the embodiments shown in the drawings, it should be understood that the embodiments disclosed can be embodied in many alternate forms of embodiments. For example, the disclosed embodiments may be implemented in hardware, software, or any combination of hardware and software. In addition, any suitable size, shape or type of elements or materials could be used. For the embodiments disclosed herein, a PSD may also be referred to as a SAFE.

As shown in FIG. 1, the system 10 generally comprises groups of PSD's referred to as pools, and programs to operate the pools.

The present invention is directed to a system that dynamically allocates PSD's among the pools according to system requirements, functions, and the condition or operating state of the PSD's.

PSD pools may be designated Indicia Pod 20, Download Pool 30, Maintenance Pool 40 and Worker Pool 50. Other designations may also be used.

The Worker pool 50 may perform PSD initialization and information acquisition. The Worker pool 50 may only include a single queue and may function generally as an initialization and holding area for PSD's. As part of the initialization process, the Worker Pool 50 may acquire a PSD ID, set a Port Number, Computer Name, and PIN for a specific: PSD 55. The PSD 55 may be allocated to any pool from the Worker's Pool 50 and the PSD 55 can be placed back into this pool from any pool.

The Indicia pool 20 utilizes one or more PSD's 25 to create indicia. The Indicia pool 20 generally acquires PSD's from the Worker pool 50. When a PSD becomes low on funds, it may be allocated to the Download pool. The Indicia pool 20 may have multiple queues, however, the number of queues may be limited by the number of available PSD'S.

If the number of Indicia queues equals the number of working PSDS, then the system may close down the Indicia queue that has no operational PSD and redistribute the indicia requests to the other Indicia queues.

The Download pool 30 provides fund replenishment for the PSD's. PSD's 35 may be allocated to the Download pool 30 from the Worker pool 50. The Download pool 30 sends a replenished PSD back to the Worker pool 50. The Download pool 30 may have a single queue that has configurable options for automated downloads.

PSD's may be allocated to the Maintenance pool 40 when they cannot perform one or more functions, are non-responsive, or are generally not working. The Maintenance pool 40 may include a single queue.

The designation “not working” may indicate a conditional problem. As an example, a particular PSD 27 may not be printing Indicia in the Indicia pool 20. The non-printing PSD 27 may be allocated to the Maintenance pool 40 where diagnostics may be performed. Based on the diagnostic results, corrective action may also be performed. As a further example, the Maintenance pool 40 may perform diagnostics that determine that the PSD's watchdog timer has elapsed. The Maintenance pool 40 may then allocate the PSD 27 to the Download pool 30 for a zero fund reset. Other corrective actions may include application or operating system downloads, PSD resets. etc. For those PSD's implemented using hardware, the Maintenance pool 40 may also determine that the PSD must be physically repaired or returned to the manufacturer.

In an exemplary operation of system 10, a PSD 57 may be first initialized into the Worker pool 50, and from there sent into the Download pool 30 to receive funds. After the funds have been received, the PSD 57 may be removed from the Download pool 30 and sent back to the Worker pool 50. Now funded, if a need arises the PSD may be removed from the Worker pool 50 and placed into the Indicia pool 20 where it may generate indicia until it runs out of funds.

The Indicia pool 20, realizing that the PSD 57 is out of funds may place the spent PSD 57 into the Download pool 30 and extract a replacement from the Worker pool 50 if a PSD is available. If a PSD is not available, the Indicia pool 20 may wait until the Download pool 30 places the PSD back into the Worker pool 50. Typical system applications may include:
A kiosk where a single PSD is installed for postage dispensing;
A high-speed/dedicated printer, where multiple PSDs create indicia at the rate of approximately 18,000-36,000 an hour (maximum limit has not yet been determined);
An internet/intranet platform where high volumes of indicia may be created by multiple users;
Page Printing such as Word; and
Dispersions of PSDs to multiple computers controlled by a single location.

One embodiment of the present invention may operate as follows: upon system initialization, all PSD's may generally be allocated to the Worker pool 50. A worker routine, or program, referred to as a worker manager 52 may interrogate the PSD's and capture each PSD's com ports, PIN number, computer name, and serial number. The worker manager 52 may also capture additional information. The worker manager 52 may report all captured information and the status of each PSD to a system management routing or program, referred to as a system manager 100.

The system manager 100 manages the overall operation of the system 10. If a PSD is determined to have no funds, this information is reported to the system manager which allocates the PSD to the Download pool 30. If a PSD is deemed to be non responsive or otherwise defective, the system manager 100 may allocate it to the Maintenance pool 40.

Upon being allocated to the Download pool 30, a download routine, or program, referred to as a download manager 32 may initiate a funds replenishment routine. The download manager 32 may initiate an unattended download where a funds provider 110 is contacted, funds are requested, and are either provided or the request is denied. One example of a funds provider 110 may be the Mailroom Technologies TMS system. The PSD itself may also be capable of initiating an unattended funds download. When a PSD is funded, the system manager 100 may allocate it to the Worker pool 50. The download manager reports the status of each PSD in the Download pool 30 to the system manager 100. If a PSD is deemed to be non responsive or otherwise defective, it may be allocated to the Maintenance pool 40.

When indicia is required, an indicia manager 22 initiates Indicia queues 115₁ . . . 115ₙ as required and initiates a request to the system manager 100 for PSD's to service the queues. In response, the system manager 100 may allocate available PSD's from the Worker pool 50 to the indicia pool. The indicia manager 22 keeps track of the capacity of each PSD in the indicia pool 20 and generates requests to add or delete PSD's as required to service the Indicia queues 115₁ . . . 115ₙ. The indicia manager 22 is also capable of reporting the status of each PSD in the indica pool 20 to the system manager 100. The indicia manager 22 may also identify problematic PSD's to the system manager 100 which in turn may allocate them to the Maintenance pool 40.

Each of the manager routines 22, 32, 42, 52 may also be capable of determining a “health” measurement or status of the PSD's within their respective pools and reporting this measurement or status to the system manager 100. PSD's that have a particular health measurement or status may be allocated to the Maintenance pool 40. PSD's that are alocated to the Maintenance pool 40 are brought under the control of a maintenance manager 42 which operates to determine their failure modes and to attempt corrective action. For example, the maintenance manager 42 may run various diagnostics and tests to determine or verify any number of failure modes. For some failures, the maintenance manager 42 may attempt to reload the operating system and any application programs of the PSD 47. Other diagnostic and corrective actions may also be attempted.

Each of the manager routines 22, 32, 42, 52 and the system manager 100 may also include an Application Program Interface that may be provide an interface to the particular manager routine for various tasks. For example, an indicia API 23 may provide interfaces to the indicia manager 22 and indicia queues 115₁ . . . 115ₙ, including functions for controlling the indicia queues 115₁ . . . 115ₙ, and creating indicia. A download API 33 may provide access to the functions performed by the download manager 32 including an interface for configuring postage downloading functions. A system manager API 103 may generally include interfaces for configuring or retrieving information about individual or groups of PSD's, interfaces for controlling what events or parameters are written to log files, and may provide interfaces to client applications or other applications outside the system 10.

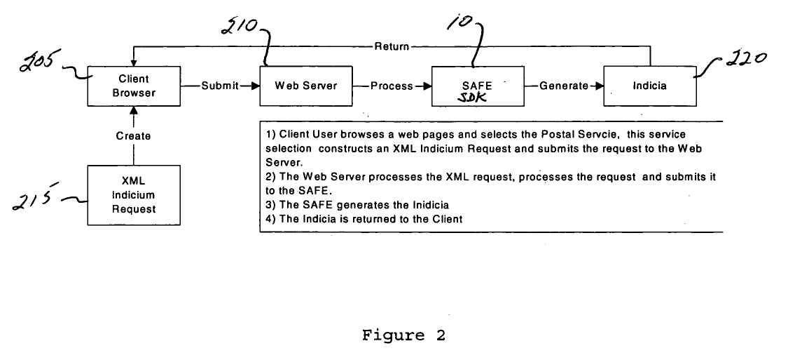

Referring to FIG. 2, the present invention may include a user interface that includes a client browser 205 and a web server 210. Exemplary system operations might begin with a user browsing a web page using client browser 205 and creating an XML indicia request 215. The indicia request 215 may be submitted to web server 210 through client browser 205. Web server 210 may process the indicia request 215 and then submit it to system 10 through system manager API 103 (FIG. 1). The system manager 100 would then direct system 10 to produce the requested indicia 220 and deliver it to client browser 205 for use by the requesting user.

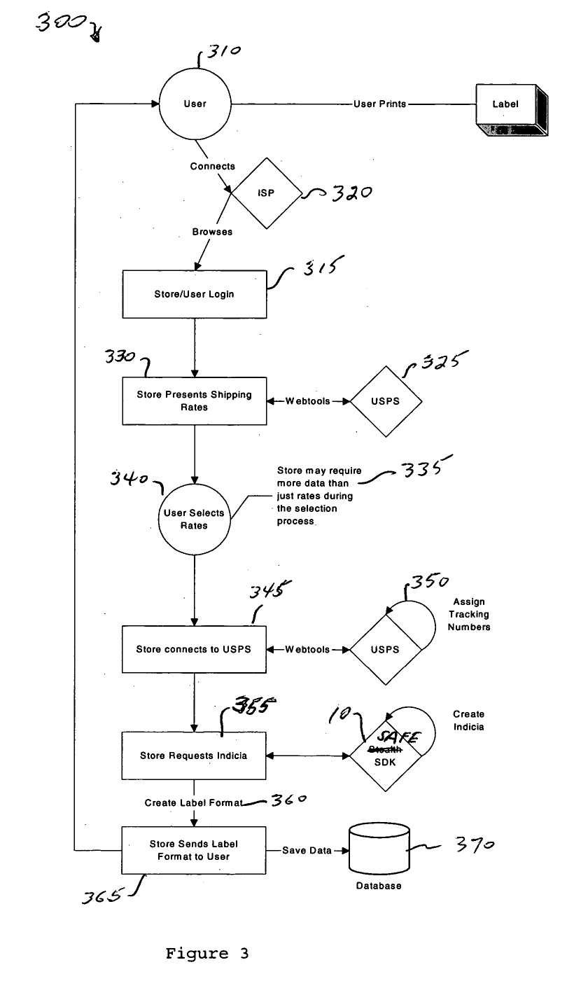

Referring to FIG. 3, the present invention may be incorporated in a retail system 300, for example, for shipping returned merchandise. A user may connect to the retail system 300, for example a web page 315, through an Internet Service Provider (ISP) 320 to request authorization to return merchandise. The retail system 0.300 may access a carrier's system to determine shipping rates and provide them to the user 330. A use may be prompted for more information 335 in the event that the retail system 300 requires additional information, and the user may then select a shipping rate 340. The retail system 300 may then connect to the carrier's system 345 and a tracking number may be assigned 350 for tracking the returned merchandise. The retail system 300 may then request indicia 355 from the system 10 through system manager API 103 (FIG. 1). Upon receiving the indicia, the retail system 300 formats a label 360, sends the label to the user 365, and stores data about the transaction 370.

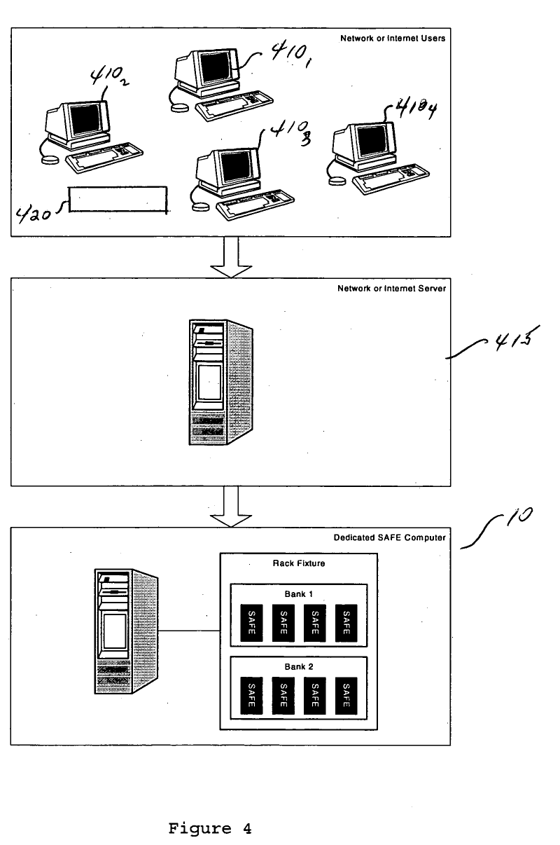

FIG. 4 shows an example of the disclosed embodiments implemented in an open system. An open system is defined as a system where a proof-of postage printing device is external to an indicia computational and generating device. As shown in FIG. 4, system 10 is connected to end users 410₁ . . . 410₄ through a server or other networking system 415. End users 410₁ . . . 410₄ are provided with a proof-of postage printing device 420 which is external to system 10. A user 410₁ . . . 410₄ requests indicia from system 10 and once generated, the indicia is delivered to user 410₁ . . . 410₄ through networking system 415. The requesting user may then print the indicia locally utilizing proof-of postage printing device 420.

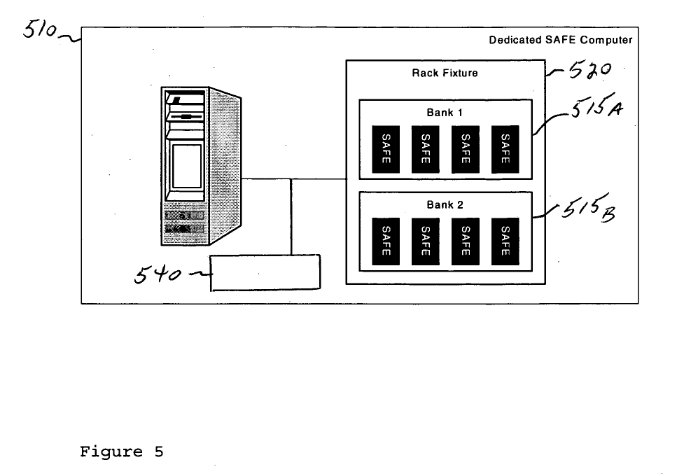

FIG. 5 shows an example of the disclosed embodiments implemented in a closed system. A closed system is defined as a system where the proof-of postage printing means are housed within the system computational means or within a cryptographically secure boundary. For example, the closed system of FIG. 5 includes a cryptographically secure boundary 510. The PSD's of this system are located in banks 515A, 515B within a rack fixture 520. A proof-of postage printing device 540 resides within cryptographically secure boundary 510.

In any of the embodiments, pools 20, 30, 40, 50 may include PSD's that are distributed, that is, are connected by a network but are not necessarily in the same physical location.

Thus, the system 10 generally provides a mechanism where multiple PSD's may produce indicia at a high rate, and a robust software architecture that provides diagnostic and corrective action in the event of PSD hardware and software failure.

While particular embodiments have been described, various alternatives, modifications, variations, improvements, and substantial equivalents that are or may be presently unforeseen may arise to Applicant's or others skilled in the in the art. Accordingly, the appended claims as filed, and as they may be amended, are intended to embrace all such alternatives, modifications, variations, improvements and substantial equivalents.

What is claimed is:

1. A system for dynamically allocating one or more postal security devices (PSD's), comprising:
an indicia pool utilizing PSD's for generating indicia;
a download pool for refreshing PSD funds; and
a means for allocating the one or more PSD's among the indicia pool and download pool according to indicia generating requirements and funding amounts within the one or more PSD's.

2. The system of claim 1, further comprising an indicia manager that initiates queues for generating indicia and requests allocation of PSD's to the indicia pool to service the indicia queues.

3. The system of claim 1, further comprising a worker pool for initializing and holding PSD's for allocation.

4. The system of claim 4, wherein the worker pool operates to sets a port number and personal identification number for a particular PSD.

5. The system of claim 1, further comprising a maintenance pool for performing diagnostics on a PSD that cannot perform one or more functions.

6. The system of claim 5, wherein the diagnostics include corrective action for correcting a failure.

7. The system of claim 6, wherein the corrective action includes reloading an operating system and an application program of the PSD that cannot perform one or more functions.

8. A method of dynamically allocating one or more postal security devices (PSD's), comprising:
creating an indicia pool utilizing PSD's for generating indicia;
creating a download pool for refreshing PSD funds; and
allocating the one or more PSD's among the indicia pool and download pool according to indicia generating requirements and funding amounts within the one or more PSD'S.

9. The method of claim 8, further comprising initiating queues for generating indicia and requesting allocation of PSD's to the indicia pool to service the indicia queues.

10. The method of claim 9, further comprising creating a worker pool for initializing and holding PSD's for allocation.

11. The method of claim 10, further comprising setting a port number and personal identification number for a PSD in the worker pool.

12. The method of claim 8, further comprising creating a maintenance pool for performing diagnostics on a PSD that cannot perform one or more functions.

13. The method of claim 12, wherein the diagnostics include corrective action for correcting a failure.

14. The method of claim 13, further comprising reloading an operating system and an application program of the PSD that cannot perform one or more functions.
